(19) United States
(12) Patent Application Publication
(10) Pub. No.: US 2005/0086334 A1
(43) Pub. Date: Apr. 21, 2005

(54) System and associated terminal, method and computer program product for recording content usage statistics

(75) Inventors: Janne La. Aaltonen, Turku (FI); Juha H. Salo, Littoinen (FI); Ari Hannikainen, Turku (FI); Larri Vermola, Turku (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/688,430

(22) Filed: Oct. 17, 2003

(51) Int. Cl. G06F 15/173

(52) U.S. Cl. 709/223

(57) ABSTRACT

A terminal for recording content usage statistics comprises a memory and a controller. The memory is capable of storing at least one piece of content. The controller, in turn, is capable of accessing at least one piece of content from the memory. The controller is also capable of operating a client application, which is capable of being triggered to obtain a location of the terminal by the controller accessing the piece(s) of content. The memory is also capable of storing, into a content usage log, at least one content usage statistic relating to the controller accessing the piece(s) of content. For example, at least one content usage statistic can include the location of the terminal. Additionally, or alternatively, for example, at least one content can include one or more statistics related to the terminal and/or the piece(s) of content accessed from the memory of the terminal.

### FIELD OF THE INVENTION

The present invention generally relates to systems and methods for recording content usage statistics and, more particularly, to systems, terminals, methods and computer program products for recording content usage statistics including a location of a terminal accessing and presenting such content.

### BACKGROUND OF THE INVENTION

The deployment of advanced high bit-rate mobile networks has opened up new opportunities for delivering a host of services in a way that was not possible with earlier second generation wireless networks. Recent systems including third generation (3G) systems, such as those specified for use with the Global System for Mobile Communications (GSM) wireless standard, enable the delivery of new digital services such as video calls and the playback of multimedia applications that are comprised of audio and video clips. Although the increased bit rates of 3G systems widen the possibilities for providing digital services.

The increased bit rates of 3G systems provide adequate performance for delivering high quality digital audio and acceptable quality moving image clips. However, at these transfer rates it may be difficult to handle exceedingly high data intensive tasks such as delivering high quality full-motion video and transferring very large data files to mobile terminals. In this regard, attempts at downloading large data files may lead to inconveniently long downloading times that can be undesirably costly for users. For this and other reasons, alternative broadband delivery techniques have been investigated that could provide a practical solution for high data intensive tasks in terms of lower cost and convenience for the users involved.

One such delivery technique that has shown promise is Digital Video Broadcasting (DVB). In this regard, DVB-T, which is related to DVB-C (cable) and DVB-S (satellite), is the terrestrial variant of the DVB standard. As is well known, DVB-T is a wireless point-to-multipoint data delivery mechanism developed for digital TV broadcasting, and is based on the MPEG-2 transport stream for the transmission of video and synchronized audio. DVB-T has the capability of efficiently transmitting large amounts of data over a broadcast channel to a high number of users at a lower cost, when compared to data transmission through mobile telecommunication networks using, e.g., 3G systems. Advantageously, DVB-T has also proven to be exceptionally robust in that it provides increased performance in geographic conditions that would normally affect other types of transmissions, such as the rapid changes of reception conditions, and hilly and mountainous terrain. On the other hand, DVB-H (handheld), which is also related to DVB-T, can provide such-increased performance particularly for wireless data delivery to a handheld devices.

Digital broadband data broadcast networks are known. As mentioned, an example of such a network enjoying popularity in Europe and elsewhere world-wide is DVB which, in addition to the delivery of television content, is capable of delivering data, such as Internet Protocol (IP) data. Other examples of broadband data broadcast networks include Japanese Terrestrial Integrated Service Digital Broadcasting (ISDB-T), Digital Audio Broadcasting (DAB), and MBMS, and those networks provided by the Advanced Television Systems Committee (ATSC). In many such systems, a containerization technique is utilized in which content for transmission is placed into MPEG-2 packets which act as data containers. Thus, the containers can be utilized to transport any suitably digitized data including, but not limited to High Definition TV, multiple channel Standard definition TV (PAUNTSC or SECAM) and, of course, broadband multimedia data and interactive services.

The combined use of mobile telecommunications with a broadband delivery technique such as DVB-T has been proposed in the past in order to achieve efficient delivery of digital services to users on the move. This would take advantage of existing infrastructures in the effort to provide personal communications (already prevalent) and the growing demand for Internet access, together with the expected rise of digital broadcasting, so that users can receive these services with a single device. Furthermore, DVB-T is a cross platform standard that is shared by many countries thereby making frequency compatibility and roaming less of an issue. The combination of mobile telecommunication and a relatively very low cost digital broadband delivery techniques provides the possibility of interactive services such as uni-directional and bi-directional services such as audio and video streaming (e.g., TV, radio, etc.), file downloads and advanced gaming applications, etc. With the possibility of interactive services, mobile terminals can be capable of downloading content, such as audio and video, file downloads and advanced gaming applications, provided by such services. In this regard, many conventional mobile terminals are capable of downloading content for online use (e.g., streaming audio and/or video), and more increasingly also offline use (e.g., storing audio and/or video for subsequent access and presentation by the mobile terminal).

As will be appreciated, more and more, society is moving into a world of information. In content delivery, statistics regarding content downloaded to terminals and the use of such content can be a critical business enabler for the availability of such content. For example, content usage statistics such as an identification of the accessed content, a type of the accessed content, a time the terminal accessed the content and/or a terminal or user identifier, can be used by content providers for a number of different purposes. In this regard, such statistics can be used by content providers, such as to modify available content, set the price of available content to users, and/or set the price of advertising associated with available content. And although conventional terminals are capable of obtaining various pieces of information regarding content downloaded, accessed and/or presented by the respective terminals, it is always desirable to obtain further information regarding such content.

In one typical scenario, statistics regarding the access of content can be used in the context of broadcast content, such as commercial and non-commercial broadcast television or radio content, where the broadcast television or radio content is typically received and presented by television sets and radios, respectively. For example, systems such as the Nielsen TV ratings system have been developed to rate television content based upon the recipients that receive and are presented with such content. In this regard, as television content is broadcast, meters typically track when respective television sets are on and what particular television content the respective television sets are presenting to respective viewers. Information in the meters is then typically collected after a period of time, typically daily, and sent to a central computing system, typically nightly.

Whereas conventional statistic collecting and rating systems are adequate in recording and rating broadcast content based upon the access and presentation of such content, such systems have drawbacks. In this regard, statistics regarding such broadcast content can ideally be utilized to, for example, modify content available to the audience, set the price of content available to the audience, and/or set the price of advertising associated with content available to the audience. But because the content is typically not tracked until the content is broadcast, and because the statistics are typically collected only after a period of time, such statistics cannot be utilized to affect the same broadcast content and advertisements that are tracked to thereby generate such statistics. Instead, historical statistics-relating to prior broadcasts of the same type of content are generally utilized for modifying and/or pricing the content that is now available, and/or for pricing the related advertising. By relying on historical statistics, errors can arise due to the passage of time, change in the audience, etc. such that the content is not modified and/or the contents or advertisements are not price properly.

### SUMMARY OF THE INVENTION

In light of the foregoing background, embodiments of the present invention provide a system and associated terminal, method and computer program product that, in contrast to conventional systems and methods, are capable of obtaining a terminal location based upon access to content at the terminal. In this regard, whereas conventional systems and methods may be capable of providing content usage statistics such as an identification of the accessed content, a type of the accessed content, a time the terminal accessed the content and/or a terminal or user identifier, embodiments of the present invention are further capable of obtaining, and thereafter providing, the location of the terminal when the terminal accesses the content. The location of the terminal can then be presented and utilized, along with the other content usage statistics, in real time or near real time for any of a number of different purposes in addition to those identified above in the background section. For example, the location of the terminal can be utilized to adapt content received by the terminal to relate to the location of the terminal when such content may be accessed. Also, for example, the location of the terminal can be utilized to adapt advertisements, which may be included in the content, to relate to commercial goods and/or services available proximate the location of the terminal when such content may be accessed.

In the context of broadcast content, the system and associated terminal, method and computer program product of embodiments of the present invention can be capable of receiving, and consequently storing and accessing, pre-broadcast content related to such broadcast content before the content is broadcast. In contrast to conventional statistic collecting and content rating techniques, then, the terminal can also be capable of recording statistics regarding this pre-broadcast content before the broadcast content is broadcast. Also in contrast to conventional statistic collecting and content rating techniques, the terminal can be capable of sending such statistics to a destination before the content is broadcast. By sending such statistics to a destination before the content is broadcast, such statistics can be utilized to affect the same content before the content is broadcast.

According to one aspect of the present invention, a terminal is provided for recording content usage statistics. The terminal comprises a memory and a controller. The memory is capable of receiving and storing at least one piece of content. The controller, in turn, is capable of accessing at least one piece of content from the memory, such as in an offline manner. For example, the piece(s) of content can comprise piece(s) of pre-broadcast content including a set of at least one television program over a given time period for at least one television channel. In such instances, the terminal can be capable of accessing the piece(s) of pre-broadcast content at least a predefined period of time before the broadcast content is broadcast. Also in such instances, the predefined period of time can comprise the given time period.

The controller is also capable of operating a client application, which is capable of being triggered to obtain a location of the terminal by the controller accessing the piece(s) of content. The memory is also capable of storing, into a content usage log, at least one content usage statistic relating to the controller accessing the piece(s) of content. For example, at least one content usage statistic can comprise the location of the terminal. Additionally, or alternatively, for example, at least one content usage statistic can comprise one or more statistics related to the terminal and/or the piece(s) of content accessed from the memory of the terminal. Further, for example, the content usage statistic(s) can comprise one or more of a type of the piece(s) of content accessed from the memory, a time the piece(s) of content were accessed from memory, information regarding used connection types, and information regarding available connection types including a signal strength, capacity and/or utilization rate of the available connection types.

More particularly, for example, the memory can be capable of receiving piece(s) of content in accordance with a broadband data broadcast technique. In such instances, the piece(s) of content can comprise piece(s) of content for one or more television, radio and/or data channels. Also, for example, the memory can be capable of receiving and storing at least one piece of pre-broadcast content related to broadcast content. In such instances, the terminal can be capable of sending the content usage log to a destination when a return channel between the terminal and the destination is available and/or established. And in instances when the piece(s) of content comprise piece(s) of pre-broadcast content, the controller can be capable of sending the content usage log to a destination before the broadcast content is broadcast. Irrespective of when the controller sends the content usage log to the destination, the destination can be capable of receiving the content usage log including the content usage statistic(s) such that a network entity is capable of sending, to the terminal, at least one piece of content based upon the at least one content usage statistic.

Advantageously, the controller can be capable of repeatedly accessing piece(s) of content. Likewise, the client application can be capable of repeatedly obtaining a location of the terminal, and the memory can be capable of repeatedly storing the content usage statistic(s). In such instances, the piece(s) of content can be accessed, the location of the terminal can be repeatedly obtained, and the content usage statistic(s) can be repeatedly stored for at least one period of time. Then, the controller can be further capable of sending the content usage log to a destination after each period of time, and in some embodiments, before the broadcast content is broadcast.

According to other aspects of the present invention, a system, method and computer program product are provided for recording content usage statistics. Therefore, embodiments of the present invention provide a system and associated terminal, method and computer program product for recording content usage statistics. The terminal, method and computer program product of embodiments of the present invention are capable of storing the location of the terminal based upon the controller of the terminal accessing content from the memory of the terminal. The location of the terminal can then be used for any of a number of different purposes in addition to those identified above in the background section.

Further, in the context of broadcast content, the system and associated terminal, method and computer program product of embodiments of the present invention can be capable of receiving, and consequently storing and accessing, such broadcast content before the content is broadcast. Further, the system and associated terminal, method and computer program product of embodiments of the present invention can be capable of recording statistics regarding this pre-broadcast content before the content is broadcast. Therefore, the system and associated terminal, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one embodiment of the present invention including a cellular network and a data network to which a terminal is bi-directionally coupled through wireless RF links;

FIG. 2 is a schematic block diagram of an entity capable of operating as a terminal, origin server, digital broadcast receiving terminal and/or a digital broadcaster, in accordance with embodiments of the present invention;

FIG. 3 is a functional block diagram of a digital broadcast receiving terminal, in accordance with one embodiment of the present invention;

FIG. 4 is a functional block diagram of the digital broadcaster, in accordance with one embodiment of the present invention;

FIG. 5 is a schematic block diagram of a mobile station that may operate as a terminal, according to embodiments of the present invention;

FIG. 6 is a flowchart of a method of recording content usage statistics in accordance with one embodiment of the present invention; and

FIG. 7 is another flowchart of a method of recording content usage statistics in accordance with another embodiment of the present invention in the context of content comprising pre-broadcast content.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

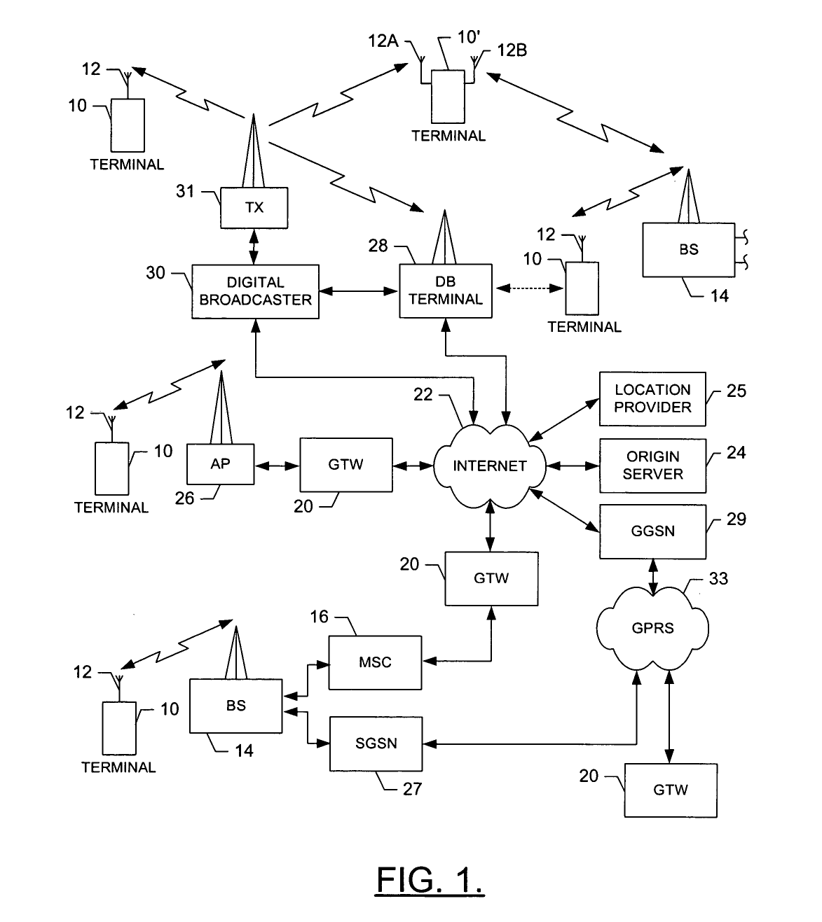

Referring to FIG. 1, an illustration of one type of terminal and system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g. Internet) applications.

As shown, a terminal 10 may include an antenna 12 for transmitting signals to and for receiving signals from a base site or base station (BS) 14. The base station is a part of a cellular network that includes elements required to operate the network, such as a mobile switching center (MSC) 16. As well known to those skilled in the art, the cellular network may also be referred to as a Base Station/MSC/Interworking function (BMI). In operation, the MSC is capable of routing calls and messages to and from the terminal when the terminal is making and receiving calls. The MSC also provides a connection to landline trunks when the terminal is involved in a call. Further, the MSC can be coupled to a server gateway (GTW) 20.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 20, and the GTW is coupled to a WAN, such as the Internet 22. In turn, devices such as processing elements (e.g., personal computers, server computers or the like) can be coupled to the terminal 10 via the Internet. For example, as explained below, the processing elements can include one or more processing elements associated with an origin server 24, a location provider 25 or the like, one of each being illustrated in FIG. 1.

In addition to the MSC 16, the BS 14 can be coupled to a signaling GPRS (General Packet Radio Service) support node (SGSN) 27. As known to those skilled in the art, the SGSN is typically capable of performing functions similar to the MSC 16 for packet switched services. The SGSN, like the MSC, can be coupled to a data network, such as the Internet 22. The SGSN can be directly coupled to the data network. In a more typical embodiment, however, the SGSN is coupled to a packet-switched core network, such as a GPRS core network 33. The packet-switched core network is then coupled to another GTW, such as a GTW GPRS support node (GGSN) 29, and the GGSN is coupled to the Internet. In addition to the GGSN, the packet-switched core network can also be coupled to a GTW 20.

By coupling the SGSN 27 to the GPRS core network 33 and the GGSN 29, devices such as origin servers 24 can be coupled to the terminal 10 via the Internet 22, SGSN and GGSN. In this regard, devices such as origin servers can communicate with the terminal across the SGSN, GPRS and GGSN. For example, origin servers can provide content to the terminal, such as in accordance with the Multimedia Broadcast Multicast Service (MBMS). For more information on the MBMS, see Third Generation Partnership Project (3GPP) technical specification 3GPP TS 22.146, entitled: Multimedia Broadcast Multicast Service (MBMS), the contents of which are hereby incorporated by reference in its entirety.

In addition to being coupled to the BS 14, the terminal 10 can be coupled to one or more wireless access points (APs) 26. The APs can comprise access points configured to communicate in accordance techniques such as, for example, radio frequency (RF), Bluetooth (BT), infrared (IrDA) or any of a number of different wireless networking techniques, including WLAN techniques. The APs may be coupled to the Internet 22. Like with the MSC 16, the APs can be directly coupled to the Internet. In one advantageous embodiment, however, the APs are indirectly coupled to the Internet via a GTW 20. As will be appreciated, by directly or indirectly connecting the terminals and the origin server 24, as well as any of a number of other devices, to the Internet, the terminals can communicate with one another, the origin server, etc., to thereby carry out various functions of the terminal, such as to transmit data, content or the like to, and/or receive content, data or the like from, the origin server. As used herein, the terms “data,” “content,” “information” and similar terms may be used to interchangeably to refer to data capable of being transmitted, received and/or stored in accordance with embodiments of the present invention. Thus, use of any such terms should not be taken to limit the spirit and scope of the present invention.

Further, the terminal 10 can additionally, or alternatively, be coupled to a digital broadcaster 30 via a digital broadcast network, such as a terrestrial digital video broadcasting (e.g., DVB-T, DVB-H, ISDB-T, ATSC, etc.) network. As will be appreciated, by directly or indirectly connecting the terminals and the digital broadcaster, the terminals can receive content, such as content for one or more television, radio and/or data channels, from the digital broadcaster. In this regard, the digital broadcaster can include, or be coupled to, a transmitter (TX) 31, such as a DVB-T TX. Similarly, the terminal can include a receiver, such as a DVB-T receiver (not shown). The terminal can be capable of receiving content from any of a number of different entities in any one or more of a different number of manners. In one embodiment, for example, the terminal can comprise a terminal 10′ capable of transmitting and/or receiving data, content or the like in accordance with a DVB (e.g., DVB-T, DVB-H, etc.) technique as well as a cellular (e.g., 1G, 2G, 2.5G, 3G, etc.) communication technique. In such an embodiment, the terminal 10′ may include an antenna 12A for receiving content from the DVB-T TX, and another antenna 12B for transmitting signals to and for receiving signals from a BS 14. For more information on such a terminal, see U.S. patent application Ser. No. 09/894,532, entitled: Receiver, filed Jun. 29, 2001, the contents of which is incorporated herein by reference in its entirety.

In addition to, or in lieu of, directly coupling the terminal 10 to the digital broadcaster 30 via the TX 31, the terminal can be coupled to a digital broadcast (DB) receiving terminal 28 which, in turn, can be coupled to the digital broadcaster 30, such as directly and/or via the TX. In such instances, the digital broadcast receiving terminal can comprise a DVB-T receiver, such as a DVB-T receiver in the form of a set top box. The terminal can be locally coupled to the digital broadcast receiving terminal, such as via a personal area network. In one advantageous embodiment, however, the terminal can additionally or alternatively be indirectly coupled to the digital broadcast receiving terminal via the Internet 22.

The location provider 25 can be arranged to receive a request for location information, such as from the terminal 10 itself. In such instances, the request for location information can include the identity of the terminal such as an international mobile subscriber identifier (IMSI), or a temporary identifier such as a temporary international mobile subscriber identifier (TIMSI). The location provider may respond to a location request with location information for the terminal. The location provider may therefore provide, on request, the current or most recent location (if available) of the terminal or, if the location determination fails, an error indication and optionally the reason for the failure. For more information on one type of location provider, often referred to as a location server, see European telecommunications Standards Institute (ETSI) technical specification entitled: Location Services (3GPP TS23.171 and GSM 03.71), the contents of which are hereby incorporated by reference in its entirety.

The location of the terminal 10, such as from the location provider 25 or the terminal itself (described below), can be defined in any of a number of different manners. For example, the location can be defined as a logical location (e.g., Boston, Boston Common, Central Park, etc.). Also, for example, the location can be defined as a set of geographic (X, Y, Z) coordinates, where the geographic (X, Y, Z) coordinates may, but need not, include a Z coordinate. In addition, for example, the location can be defined as a set of geographic latitude and longitude coordinates. Further, the location can be defined by a cell ID, where the location can be defined as a cell identifier that identifies a geographic area through the coverage area of the cell (e.g., GSM cell) associated with the cell ID.

The location provider 25 can be implemented in the core network and be arranged to determine the location of the terminal 10 in any of a number of different manners. For example, the location provider can be capable of determining the location of the terminal based upon location information from the wireless communication network via the MSC 16 and/or a serving general packet radio service support node (SGSN) (not shown). Additionally or alternatively, for example, the location provider can determine the location of the terminal in accordance with any of a number of other techniques including, for example, triangulation, Global Positioning System (GPS), Assisted GPS (A-GPS), Time of Arrival (TOA), Observed Time Difference of Arrival (OTDOA) or the like, as such are well known to those skilled in the art.

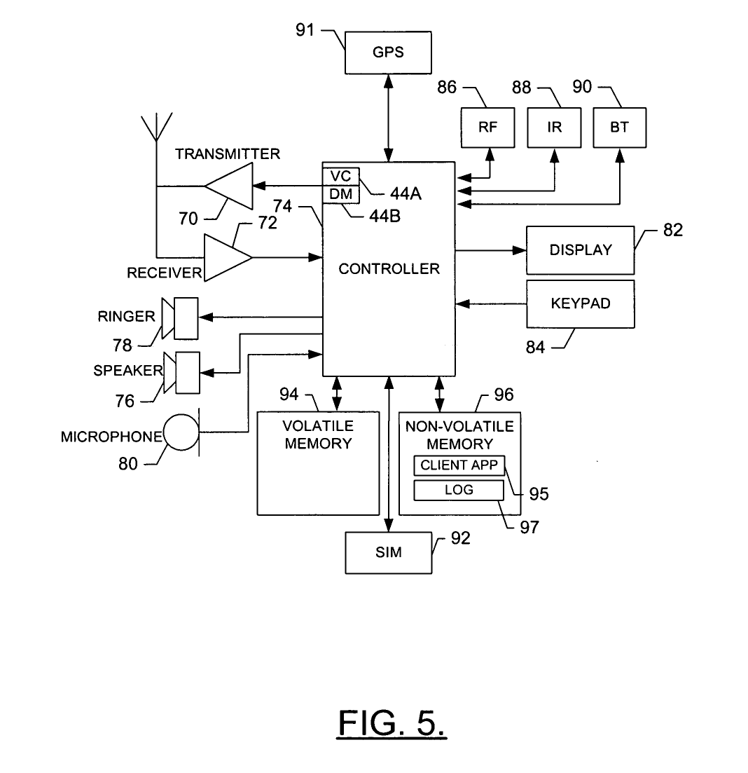

Although shown and described herein as being coupled to the Internet 22, it should be appreciated that the location provider 25 may be logically located anywhere in the data network and/or wireless communications network. Also, the location provider may be distributed between several elements of the network, or may be implemented in a single element. In addition, the location provider may also be an external node to the wireless communications network. Further, for example, the terminal 10 may include the location provider (e.g., GPS sensor 91 see FIG. 5), and thus provide the location provider functionality. In such instances, the terminal is capable of generating location information thereof.

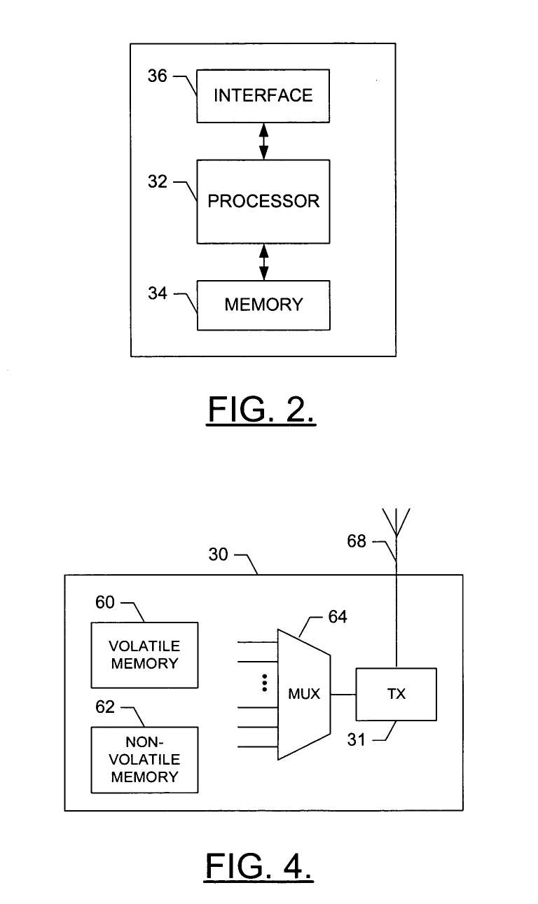

Referring now to FIG. 2, a block diagram of an entity capable of operating as a terminal 10, origin server 24, digital broadcast receiving terminal 28, and/or a digital broadcaster 30 is shown in accordance with one embodiment of the present invention. Although shown as separate entities, in some embodiments, one or more entities may support one or more of a terminal, origin server, digital broadcast receiving terminal, and/or a digital broadcaster, logically separated but co-located within the entit(ies). For example, a single entity may support a logically separate, but co-located, terminal and digital broadcast receiving terminal. Also, for example, a single entity may support a logically separate, but co-located digital broadcast receiving terminal and digital broadcaster.

As shown, the entity capable of operating as a terminal 10, origin server 24, digital broadcast receiving terminal 28, and/or a digital broadcaster 30 can generally include a processor 32 connected to a memory 34. The processor can also be connected to at least one interface 36 or other means for transmitting and/or receiving data, content or the like. The memory can comprise volatile and/or non-volatile memory, and typically stores content, data or the like. For example, the memory typically stores software applications, instructions or the like for the processor to perform steps associated with operation of the entity in accordance with embodiments of the present invention. Also, for example, the memory typically stores content transmitted from, or received by, the terminal, digital broadcast receiving terminal, and/or digital broadcaster.

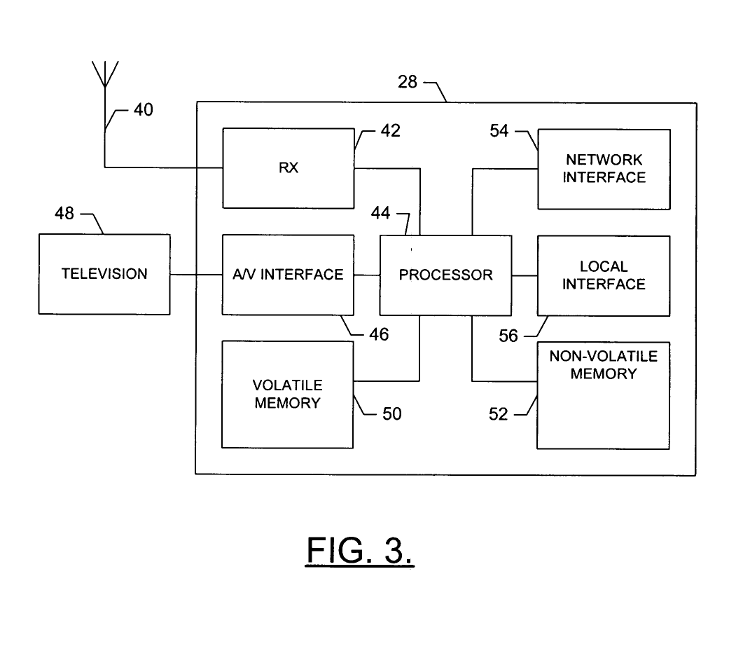

Reference is now made to FIG. 3, which illustrates a functional block diagram of a digital broadcast receiving terminal 28, in accordance with one embodiment of the present invention. As shown, the digital broadcast receiving terminal includes an antenna 40 for receiving signals from a digital broadcaster 30 and feeding the signals into a receiver (RX) 42. In turn, the receiver is capable of decrypting, demodulating and/or demultiplexing the signals, such as to extract content data. The receiver can feed the content data to a processor 44, which can thereafter decode the content data. The processor can then feed the decoded signal into an audio/video (A/V) interface 46, which can convert signals to a form suitable for display by a monitor, such as a television set 48.

The digital broadcast receiving terminal 28 can include volatile memory 50, such as volatile Random Access Memory (RAM) including a cache area for the temporary storage of data. The digital broadcast receiving terminal can also include non-volatile memory 52, which can be embedded and/or may be removable. The non-volatile memory can additionally or alternatively comprise an EEPROM, flash memory, hard disk or the like. The memories can store any of a number of pieces of information, content and data, used by the digital broadcast receiving terminal to implement the functions of the digital broadcast receiving terminal. For example, as indicated above, the memories can store content, such as that received from a digital broadcaster 30.

The digital broadcast receiving terminal 28 can also include one or more interface means for sharing and/or obtaining data from electronic devices, such as terminals 10 and/or digital broadcasters 30. More particularly, the digital broadcast receiving terminal can include a network interface means 54, for sharing and/or obtaining data from a network, such as the Internet 22. For example, the digital broadcast receiving terminal can include an Ethernet Personal Computer Memory Card International Association (PCMCIA) card configured to transmit and/or receive data to and from a network, such as the Internet.

The digital broadcast receiving terminal 28 can also include one or more local interface means 56 for locally sharing and/or obtaining data from electronic devices, such as a terminal. For example, the digital broadcast receiving terminal can include a radio frequency transceiver and/or an infrared (IR) transceiver so that data can be shared with and/or obtained in accordance with radio frequency and/or infrared transfer techniques. Additionally, or alternatively, for example, the digital broadcast receiving terminal can include a Bluetooth (BT) transceiver operating using Bluetooth brand wireless technology developed by the Bluetooth Special Interest Group such that the digital broadcast receiving terminal can share and/or obtain data in accordance with Bluetooth transfer techniques. Further, the digital broadcast receiving terminal can additionally or alternatively be capable of sharing and/or obtaining data in accordance with any of a number of different wireline and/or wireless networking techniques, including LAN and/or WLAN techniques.

Reference is now made to FIG. 4, which illustrates a functional block diagram of the digital broadcaster 30 of one embodiment of the present invention. Like the digital broadcast receiving terminal 28, the digital broadcaster can include volatile memory 60, such as volatile Random Access Memory (RAM) including a cache area for the temporary storage of data. The digital broadcaster can also include non-volatile memory 62, which can be embedded and/or may be removable. The non-volatile memory can additionally or alternatively comprise an EEPROM, flash memory, hard disk or the like. The memories can store any of a number of pieces of information, content and data, used by the digital broadcaster to implement the functions of the digital broadcaster. For example, as indicated above, the memories can store content, such as content for a television channel and other content for a number of other television, radio and/or data channels.

The digital broadcaster 30 can also include a multiplexer 64, which can be capable of multiplexing content for a number of television, radio and/or data channels. The multiplexer can then feed the resulting signal into a TX 31, which can be separate from the digital broadcaster, as shown in FIG. 1, or incorporated within the digital broadcaster, as shown in FIG. 4. Irrespective of where the TX is located relative to the digital broadcaster, the TX can receive the signal from the multiplexer for encryption, modulation, amplification and/or transmission, such as via an antenna 68. In this regard, for example, the digital broadcaster can be capable of directly or indirectly transmitting content to a digital broadcast receiving terminal 28 and/or a terminal 10, such as in accordance with a digital broadcasting technique, such as DVB-T. For information on DVB-T, see European Telecommunications Standards Institute (ETSI) Standard EN 300 744, entitled: Digital Video Broadcasting (DVB): Framing structure, channel coding and modulation for digital terrestrial television, v.1.1.2 (1997) and related specifications, the contents of which are hereby incorporated by reference in their entirety.

In accordance with a number of digital broadcasting techniques, such as DVB-T, Internet Protocol (IP) Datacast (IPDC) can be utilized to provide audio, video and/or other content to terminals 10. In this regard, the digital broadcaster 30 can be capable of providing IP datacasting content to the terminal utilizing a digital broadcasting technique. As will be appreciated by those skilled in the art, digital broadcasting techniques such as DVB-T are essentially cellular in nature with a transmission site associated with each of a number of different cells. DVB-T, for example, uses MPEG-2 transport streams, and as such, IP data can be encapsulated into DVB transmission signals sent from the digital broadcaster, or more particularly the TX 31. Data streams including IP datagrams can be supplied from several sources, and can be encapsulated by an IP encapsulator (not shown). The IP encapsulator, in turn, can feed the encapsulated IP data streams into the data broadcasting (e.g., DVB-T) network.

The encapsulated IP data streams can then be transported to one or more transmission sites, where the transmission sites form cells of the data broadcasting network. For example, the encapsulated IP data streams can be transported to one or more transmission sites on an MPEG-2 transport stream for subsequent transmission over the air directly to the terminals, or to a receiver station serving one or more terminals. As will be appreciated, the MPEG-2 transport stream, from production by the IP encapsulator, to reception by the terminals or the receiver station, is typically uni-directional in nature. In this regard, IP packets containing the data can be embedded in multi-protocol encapsulation (MPE) sections that are transported within transport stream packets.

In addition to the IP packets, the MPE sections can also include forward error correction (FEC) information and time slicing information. By including information such as time slicing information, data can be conveyed discontinuously with the receiver (e.g, terminal 10), being capable of saving battery power by switching off when no data is being transmitted to the receiver. In other terms, in accordance with one time slicing technique, instead of using the current default method of continuous digital broadcasting (e.g., DVB-T) transmission, a time division multiplex-type of allocation technique can be employed (see, e.g., DVB-H standard). With such an approach, then, services can be provided in bursts, allowing a receiver to power down when the receiver is not receiving data, and allowing the receiver to power up to receive data packets, as necessary.

FIG. 5 illustrates a functional diagram of a mobile station that may operate as a terminal 10, according to embodiments of the invention. It should be understood, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes a transmitter 70, a receiver 72, and a controller 74 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1G), second-generation (2G), 2.5G and/or third-generation (3G) communication protocols or the like. For example, the mobile station may be capable of operating in accordance with 2G wireless communication protocols IS-136 (TDMA), GSM, and IS-95 (CDMA). The mobile station can additionally or alternatively be capable of operating in accordance with any of a number of different digital broadcasting techniques, such as the DVB technique (e.g., DVB-T, ETSI Standard EN 300 744). The mobile station can also be capable of operating in accordance with any of a number of different broadcast and/or multicast techniques, such as the MBMS technique (e.g., 3GPP TS 22.146). Further, the mobile station can be capable of operating in accordance with ISDB-T, DAB, ATSC techniques or the like. Some narrow-band AMPS (NAMPS), as well as TACS, mobile stations may also benefit from embodiments of the present invention, as should dual or higher mode mobile stations (e.g., digital/analog or TDMA/CDMA/analog phones).

It is understood that the controller 74 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 74A, and may include an internal data modem (DM) 74B. Further, the controller may include the functionally to operate one or more software applications, which may be stored in memory.

The mobile station also comprises a user interface including a conventional earphone or speaker 76, a ringer 78, a microphone 80, a display 82, and a user input interface, all of which are coupled to the controller 74. The user input interface, which allows the mobile station to receive data, can comprise any of a number of devices allowing the mobile station to receive data, such as a keypad 84, a touch display (not shown) or other input device. In embodiments including a keypad, the keypad includes the conventional numeric (0-9) and related keys (#, *), and other keys used for operating the mobile station.

The mobile station can also include one or more means for sharing and/or obtaining data from electronic devices, such as another terminal 10, an origin server 24, an AP 26, a digital broadcast receiving terminal 28, a digital broadcaster 30 or the like, in accordance with any of a number of different wireline and/or wireless techniques. For example, the mobile station can include a radio frequency (RF) transceiver 86 and/or an infrared (IR) transceiver 88 such that the mobile station can share and/or obtain data in accordance with radio frequency and/or infrared techniques. Also, for example, the mobile station can include a Bluetooth (BT) transceiver 90 such that the mobile station can share and/or obtain data in accordance with Bluetooth transfer techniques. Although not shown, the mobile station may additionally or alternatively be capable of transmitting and/or receiving data from electronic devices according to a number of different wireline and/or wireless networking techniques, including LAN and/or WLAN techniques. In this regard, as shown in FIG. 1 with respect to terminal 10′, the mobile station may include an additional antenna or the like to transmit and/or receive data from such electronic devices (e.g., digital broadcaster).

In addition, the mobile station can include one or more positioning sensors capable of determining a location of the mobile station. For example, the mobile station can include a positioning sensor comprising a GPS sensor 91 capable of determining a location of the mobile station, such as longitudinal and latitudinal directions of the mobile station. Additionally or alternatively, for example, the mobile station can include a positioning sensor comprising a radio beacon triangulation sensor that determines the location of the wireless device by means of a network of radio beacons, base stations, or access points, as is described for example, in Nokia European patent EP 0 767 594 A3, entitled: Mobile Station Positioning System, published on May 12, 1999, the contents of which are hereby incorporated by reference in its entirety.

The mobile station can further include memory, such as a subscriber identity module (SIM) 92, a removable user identity module (R-UIM) or the like, which typically stores information elements related to a mobile subscriber. In addition to the SIM, the mobile station can include other memory. In this regard, like the digital broadcast receiving terminal 28 and the digital broadcaster 30, the mobile station can include volatile memory 94. Also, again like the digital broadcast receiving terminal and the digital broadcaster, the mobile station can include other non-volatile memory 96, which can be embedded and/or may be removable. For example, the other non-volatile memory can comprise embedded or removable multimedia memory cards (MMC's), Memory Sticks manufactured by Sony Corporation, EEPROM, flash memory, hard disk or the like, such as that available from the SanDisk Corporation of Sunnyvale, Calif., or Lexar Media Inc. of Fremont, Calif.

The memories 92, 94, 96 can store any of a number of pieces of information, and data, used by the mobile station to implement the functions of the mobile station. For example, the memories can store an identifier, such as an international mobile equipment identification (IMEI) code, capable of uniquely identifying the mobile station, such as to the MSC 16. The memories can also store content, such as that received from an origin server 24 and/or a digital broadcast receiving terminal. Also, for example, the memories can store user or host applications such as a conventional text viewer, audio player, video player, multimedia viewer or the like. In addition, for example, the controller can store a client application 95 capable of obtaining the location of the terminal at one or more times when the terminal accesses one or more pieces of content stored in the memories, as described in more detail below. As also explained in more detail below, the memories can further store a content usage log 97 of one or more statistics regarding access of one or more pieces of content stored in the memories, including the location(s) of the terminal obtained by the client application.

As indicated in the background section, although conventional terminals are capable of obtaining various historical statistics regarding the access of content stored by the terminal, it is always desirable to obtain further information regarding the access of such content. As such, and in accordance with embodiments of the present invention, the terminal 10 is capable of accessing one or more pieces of content stored in memory (e.g., non-volatile memory 96) of the terminal. In response to accessing the piece(s) of content, then, the location of the terminal is capable of being obtained. In this regard, the location of the terminal can be obtained at an instance of the terminal accessing content stored in memory of the terminal. The location of the terminal, along with one or more other statistics regarding the content access, can then be stored by the terminal, such as in a content usage log 97. The content usage log can thereafter be utilized, such as by an origin server 24 operating as a statistics server, for any of a number of different purposes, such as to modify available content, set the price of available content to users, and/or set the price of advertising associated with available content.

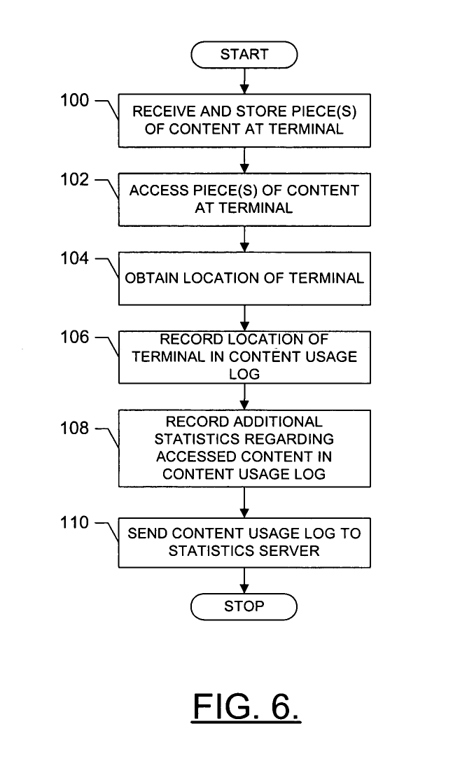

Reference is now made to FIG. 6, which illustrates various steps in a method of recording content usage statistics in accordance with one embodiment of the present invention. As shown in block 100, a method of recording content usage statistics generally includes receiving and storing one or more pieces of content at a terminal 10. The content can comprise any of a number of different types of content, and can be received at the terminal in accordance with any of a number of different wireline and/or wireless transfer techniques. For example, the content can comprise textual, audio, video and/or multimedia content capable of being received at the terminal in accordance with communication techniques such 1G, 2G, 2.5G and/or 3G wireless communication techniques, and/or in accordance with techniques such as infrared, radio frequency, Bluetooth and/or WLAN transfer techniques. In one advantageous embodiment, however, the content can comprise textual, audio, video and/or multimedia content for one or more television, radio and/or data channels. In such instances, the content can be capable of being received by the terminal from the digital broadcast receiving terminal 28 and/or the digital broadcaster 30, for example, in accordance with a broadband data broadcast technique such as a DVB technique (e.g., DVB-T, ETSI Standard EN 300 744).

After the terminal 10 stores the piece(s) of content, and as the terminal maintains the stored piece(s) of content in memory (e.g., non-volatile memory 96), the terminal can access one or more pieces of content, as shown in block 102. In this regard, as the terminal maintains the stored piece(s) of content, a user of the terminal may desire to access and present one or more pieces of content. For example, a user of the terminal may desire to direct a conventional text viewer, audio player, video player, multimedia viewer or the like, operating on the terminal, to access and present an appropriate piece of content. And although the terminal can access piece(s) of content in any of a number of different manners, in one embodiment, the user can select one or more pieces of content to thereby direct the terminal, or more particularly a respective application operating on the terminal, to access the selected piece(s) of content from memory, as shown in block 102. Thereafter, the respective application operating on the terminal can present the selected piece(s) of content in a manner appropriate for the type of the piece(s) of content and the respective application.

Irrespective of how the terminal accesses the piece(s) of content, after the terminal accesses the piece(s) of content, the terminal, or more particularly the client application 95, can obtain the location of the terminal 10, as shown in block 104. The client application can obtain the location of the terminal in any of a number of different manners, such as from the terminal itself or from the location provider 28. For example, the terminal can be responsible for determining its current location, and passing the current location to the client application. In such instances, the terminal can determine its current location in any of a number of different manners. For example, the terminal can be capable of determining its current location based upon information obtained by the access technology of the terminal, such as the current cell ID. Additionally, or alternatively, the terminal can determine its current location from sources local to, or distributed from, the terminal. For example, the terminal can determine its current location from a GPS sensor, such as GPS sensor 91 (see FIG. 5).

In addition to, or in lieu of, the terminal 10 determining its current location and passing its current location to the client application 95, the location provider 28 can be responsible for determining the current location. In this regard, the location provider can determine the location of the terminal, such as in accordance with any of the number of manners described above and known to those skilled in the art. After determining the location of the terminal, the location provider can then send the location to the terminal, or more particularly the client application, such as accordance with any of a number of different known techniques.

Irrespective of how the client application 95 obtains the location of the terminal 10, after obtaining the location of the terminal, the client application can store the location of the terminal in the content usage log 97 along with an identification, such as a name, of the accessed piece(s) of content, as shown in block 106. As will be appreciated, the client application can merely store the location of the terminal and identification of the respective accessed piece(s) of content. According to advantageous embodiments of the present invention, however, the client application stores the identification of the accessed piece(s) of content along with the location of the terminal and a number of different statistics related to the terminal and/or the piece(s) of content accessed by the terminal, as shown in block 108. For example, in addition to the identification and location of the terminal, the client application can store statistics such as a type of the accessed content (e.g., textual, audio, video and/or multimedia content), a time the terminal accessed the content and/or a terminal or user identifier (e.g., IMEI code). In addition, the client application can store statistics such as information regarding used connection types (e.g., GSM, CDMA, BT, WLAN, etc.), as well as information regarding available connection types, such as the signal strength, capacity and/or utilization rate of available connection types.

As will be appreciated, after the client application 95 stores the identification of the accessed piece(s) of content along with the location of the terminal and any other statistics in the content usage log 97, the terminal can send the content usage log to a destination, such as an origin server 24 operating as a statistics server, as shown in block 110. In a more typical embodiment, however, the terminal 10 maintains the content usage log for a period of time over which the terminal accesses one or more pieces of content at one or more different times. At each different time the terminal accesses piece(s) of content, the client application can obtain and record the identifier of the accessed piece(s) of content along with the location of the terminal and any other statistics. After a period of time, then, the content usage log can include a collection of one or more identifications of one or more pieces of content accessed by the terminal at one or more different times, along with the location of the terminal and any other statistics for each piece of content for each time the terminal accessed the respective piece of content. Thereafter, the terminal can send the content usage log to a destination (e.g., an origin server). For example, the terminal can send the content usage log to the destination when the terminal receives one or more subsequent pieces of content from a source of such content (e.g., digital broadcaster 30). Also, for example, the terminal can send the content usage log to the destination when a return channel between the terminal and the destination is available and/or established.

As explained above, the terminal receives and stores one or more pieces of content (see block 100) and thereafter accesses one or more pieces of content (see block 102). In this regard, the piece(s) of content can be received, stored and accessed in an online manner. For example, the piece(s) of content can be received, stored and accessed in a streaming manner, with the stored piece(s) of content typically comprising a buffer before and/or during presentation by a respective application. Advantageously, the piece(s) of content can additionally or alternatively be received, stored and accessed in an offline manner. In such instances, the terminal 10 can receive and store the piece(s) of content. Then, at some time after communicating with the source of the piece(s) of content to receive the content, and after storing the piece(s) of content, the terminal can access one or more of the stored piece(s) of content.

As also explained above, the terminal 10, or more particularly the client application 95, can obtain and store the location of the terminal (and any other statistics) at the time(s) when the terminal accesses one or more piece(s) of content. It should be understood, however, that the client application can additionally or alternatively be configured to obtain and store the location of the terminal (and any other statistics) at one or more times when the terminal receives one or more pieces of content and/or stores the received piece(s) of content. Further, the client application can additionally or alternatively be configured to obtain and store the location of the terminal (and any other statistics) at one or more times when the client application operates without the terminal receiving, storing and/or accessing one or more pieces of content, such as in response to other predefined events, at certain times or the like.

After the terminal 10 sends the content usage log 97 to a destination, such as an origin server 24 operating as a statistics server, the statistics server can use the content usage statistics in the content usage log for any of a number of different purposes. For example, the statistics server can use the content usage statistics to modify content available to the terminal, set the price of content available to the terminal, and/or set the price of advertising associated with content available to the terminal. Also, for example, by including the location of the terminal in the content usage statistics, the statistics server can use the statistics to adapt content received by the terminal to relate to the location of the terminal when such content may be accessed. Also, for example, the statistics server can use the location of the terminal to adapt advertisements, which may be included in the content, to relate to commercial goods and/or services available proximate the location of the terminal when such content may be accessed.

As an example of utilization of content usage statistics, consider the context of broadcast content, such as commercial and non-commercial broadcast television or radio content, where the broadcast television or radio content is typically received and presented by television sets and radios, respectively. As well known to those skilled in the art, systems have been developed to rate television and radio content based upon the recipients that receive and are presented with such content. For example, Nielsen TV ratings, which are a service of Nielsen Media Research of New York, N.Y., collect statistics regarding the receipt and presentation of television content to thereby determine the audience for such content. To collect such statistics for broadcast television content, ratings providers such as Nielsen Media Research, typically install meters directly or indirectly on television sets. In this regard, as television content is broadcast, the meters automatically track when respective television sets are on and what particular television content, such as the content from a particular television channel, the respective television sets are presenting to respective viewers. Information in the meters is then typically collected after a period of time, typically daily, and sent to a central computing system, typically nightly.

Because statistics regarding broadcast content, such as broadcast television and radio content, are typically tracked as the content is broadcast and presented to an audience, and because such statistics are typically collected only after a period of time, statistics regarding such content can be inefficiently utilized for their intended purpose. In this regard, statistics regarding such broadcast content can ideally be utilized to, for example, modify content available to the audience, set the price of content available to the audience, and/or set the price of advertising associated with content available to the audience. But because the content is typically not tracked until the content is broadcast, and because the statistics are typically collected only after a period of time, such statistics cannot be utilized to affect the same broadcast content and advertisements that are tracked to thereby generate such statistics and can, instead, only be used to predict future behaviour based upon past performance.

As explained above, the terminal 10 can be capable of receiving, storing, accessing and recording statistics regarding content. In this regard, the terminal can be capable of receiving, storing, accessing and recording statistics regarding broadcast content, such as broadcast television and/or radio content. Advantageously, the terminal of embodiments of the present invention can receive, and consequently store and access, such broadcast content before the content is publicly broadcast, such as before the content is publicly broadcast to television sets and/or radios. In contrast to conventional statistic collecting and content rating techniques, then, the terminal can also be capable of recording statistics regarding such broadcast content before the content is broadcast. Also in contrast to conventional statistic collecting and content rating techniques, the terminal can be capable of sending such statistics to a destination before the content is broadcast. By sending such statistics to a destination before the content is broadcast, such statistics can be utilized to affect the same content before the content is broadcast.

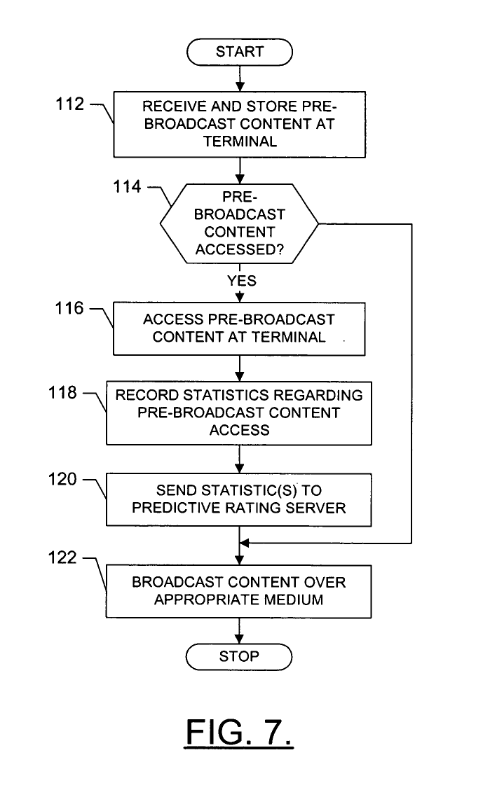

Reference will now be made to FIG. 7, which illustrates various steps of another method of recording content usage statistics in accordance with another embodiment of the present invention in the context of content comprising pre-broadcast content. As shown in block 112, a method of recording content usage statistics according to another embodiment generally includes, as before, receiving and storing one or more pieces of pre-broadcast content at a terminal. As described below, the terminal described herein with respect to the embodiment of FIG. 7 typically comprises terminal 10. It should be understood, however, that the terminal can equally comprise a digital broadcast receiving terminal 28, without departing from the spirit and scope of the present invention.

As explained above, the pre-broadcast content can comprise any of a number of different types of content, and can be received at the terminal in accordance with any of a number of different wireline and/or wireless transfer techniques. In one advantageous embodiment, the pre-broadcast content comprises content for one or more television and/or radio channels. For example, the pre-broadcast content can comprise one or more television programs, including a single television program, a set of one or more television programs, or a set of television programs over a given time period (e.g., a day) for one or more television channels. Additionally, or alternatively, the pre-broadcast content can comprise content, such as previews, relating to other content for one or more television and/or radio channels. For example, the pre-broadcast content can comprise audio and/or video traitors, clips or the like regarding content for one or more television and/or radio channels. Also, for example, the pre-broadcast content can comprise content promoting other content for one or more television and/or radio channels, such as special editions and/or interviews with those persons (e.g., actors) involved in producing the respective content.

After the terminal 10 stores the piece(s) of pre-broadcast content, and as the terminal maintains the stored piece(s) of content in memory (e.g., non-volatile memory 96), the terminal, or more particularly the client application 95, can monitor the stored piece(s) of content to determine if, and when, the terminal accesses one or more of the stored piece(s) of content, as shown in block 114. Advantageously, the client application can monitor the stored piece(s) of pre-broadcast content before the content is broadcast, such as to television sets and/or radios. In this regard, the terminal can receive and store the piece(s) of content at least a predefined period of time prior to broadcast of the respective piece(s) of content. The predefined period of time can comprise a number of minutes, hours, days or the like to thereby allow the client application to monitor access of the content, collected statistics regarding access of the content and send the content to a destination before the content is broadcast, as explained below.

As explained above, for example, the pre-broadcast content can comprise a set of one or more television programs over a given time period (e.g., one or more days) for one or more television channels. In such instances, the predefined period of time can comprise, for example, at least the given time period (e.g., one day, two days, three days, etc.). By allowing the terminal 10 to receive and store such pre-broadcast content for such a period of time allows a user of the terminal to view or otherwise be presented with the set of television program(s) the given time period before such content is broadcast (e.g., publicly broadcast). The content can thus be accessed at the terminal, the user of the terminal can be presented with the content, and statistics regarding such content can be recorded before the content is broadcast.

As the client application monitors the piece(s) of content in memory, the terminal 10 can access one or more of the stored piece(s) of content, as shown in block 116. The terminal can access one or more of the stored piece(s) of content in any of a number of different manners. For example, as explained above, a user of the terminal can direct a conventional text viewer, audio player, video player, multimedia viewer or the like, operating on the terminal, to access and present an appropriate, selected piece of content. Thereafter, the respective application operating on the terminal can present the selected piece(s) of content in a manner appropriate for the type of the piece(s) of content and the respective application.

Irrespective of how the terminal 10 accesses one or more of the stored piece(s) of content, after accessing the piece(s) of content, the client application 95 can store statistics regarding the access of the piece(s) of content, as shown in block 118. In this regard, the client application can store an identification of the accessed piece(s) of content in the content usage log 97 along with one or more statistics regarding the terminal, the user of the terminal, and/or the accessed piece(s) of content. For example, the client application can store statistics such as a type of the accessed content (e.g., textual, audio, video and/or multimedia content), a time the terminal accessed the content and/or a terminal or user identifier (e.g., IMEI code). Also, for example, the client application can store information regarding an amount of time an application presented the respective piece(s) of content to the user of the terminal. In addition, for example, the client application can store information regarding the user of the terminal, such as one or more comments, opinions or the like of the user regarding the pre-broadcast content. To store information such as opinions of the user, however, the terminal, or more particularly the client application, may present a questionnaire including one or more questions soliciting the opinions.

As shown and explained above with respect to FIG. 6, the client application 95 can obtain a location of the terminal 10 upon access of one or more pieces of content. It should be understood, however, that the client application need not, but can if so desired, obtain or store the location of the terminal in the embodiment shown and described with respect to FIG. 7. In such instances, particularly when the terminal comprises the digital broadcast receiving terminal 28, the location of the terminal upon access of the content may not be useful to a content provider providing broadcast content such as content for one or more television and/or radio channels.

After the client application 95 stores statistics regarding the access of the piece(s) of pre-broadcast content in the content usage log 97, the terminal 10 can send the content usage log to a destination, such as an origin server 24 operating as a statistics or predictive ratings server, as shown in block 120. Although the terminal typically sends the content usage log to the destination after the terminal accesses, or after an application presents, the piece(s) of content, the terminal can maintain the content usage log for a period of time over which the terminal accesses one or more pieces of content at one or more different times, as explained above with respect to FIG. 6. Even in such instances as the terminal maintains the content usage log, however, the terminal typically sends the content usage log to the destination before the pre-broadcast content is broadcast, or before related content is broadcast when the pre-broadcast content comprises content related to subsequently broadcast content.

After the client application 95 sends the content usage log 97 to a destination such as an origin server 24 operating as a predictive ratings server, the pre-broadcast content (or related content) can be broadcast, such as from the digital broadcaster 30 to conventional television sets and/or radios. In this regard, the pre-broadcast or related content are typically subsequently broadcast in a manner different from the manner in which the terminal received the pre-broadcast content. The users of the terminals can therefore represent a smaller subset of an audience that can subsequently receive the pre-broadcast or related content, such as from a public broadcast of such content. As the audience subsequently receives such broadcast content, the audience can be presented with such broadcast content over devices such as television sets, radios or the like.

By sending the content usage log to the predictive ratings server before the pre-broadcast or related content is broadcast, the predictive ratings server or another entity associated with the predictive ratings server can utilize the statistics in the content usage log. The predictive ratings server can use the content usage statistics in the content usage log for any of a number of different purposes. For example, the predictive ratings server can use the content usage statistics to modify the pre-broadcast content before the same content is broadcast such that the modified content is eventually broadcast. Also, for example, the predictive ratings server can use the content usage statistics to set the price and/or position of advertising broadcast along with the broadcast content.

As explained above, systems such as the Nielsen TV rating system collect statistics regarding the receipt and presentation of television content. But because the such systems wait until content is broadcast to track the content, and because such systems typically collect the statistics only after a period of time, such statistics cannot be utilized to affect the same broadcast content and advertisements that are tracked to thereby generate such statistics. To overcome such deficiencies of conventional statistic collection and rating systems, embodiments of the present invention are capable of storing statistics regarding broadcast content before such content is broadcast. In this regard, the statistics collected by the terminal 10 in accordance with embodiments of the present invention can be utilized independent of statistics collected by conventional systems such as the Nielsen rating system. It should be understood, however, that the statistics collected by the terminal in accordance with embodiments of the present invention can additionally or alternatively be utilized in combination with statistics collected by conventional systems such as the Nielsen rating system, without departing from the spirit and scope of the present invention.

According to one aspect of the present invention, all or a portion of the system of the present invention, such all or portions of the terminal 10, digital broadcast receiving terminal 28, and/or a digital broadcaster 30, generally operates under control of a computer program product (e.g., client application 95). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 6 and 7 are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowcharts. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the flowcharts.

Accordingly, blocks or steps of the flowcharts support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for recording at least one content usage statistic comprising:
a terminal capable of being triggered to obtain a location of the terminal by accessing at least one piece of content, wherein the terminal is also capable of storing, into a content usage log, at least one content usage statistic relating to the terminal accessing the at least one piece of content, and wherein at least one content usage statistic comprises the location of the terminal; and
a destination capable of receiving the content usage log including the at least one content usage.

2. A system according to claim 1, wherein the terminal is capable of receiving at least one piece of content in accordance with a broadband data broadcast technique, and wherein the at least one piece of content comprises at least one piece of content for at least one channel comprising at least one of a television, radio and data channel.

3. A system according to claim 2, wherein the terminal is capable of sending the content usage log to the destination when a return channel between the terminal and the destination is at least one of available and established.

4. A system according to claim 1, wherein the terminal is capable of accessing at least one piece of content comprising at least one piece of pre-broadcast content related to broadcast content, and wherein the terminal is capable of sending the content usage log to the destination before the broadcast content is broadcast.

5. A system according to claim 4, wherein the at least one piece of pre-broadcast content comprises a set of at least one television program over a given time period for at least one television channel, wherein the terminal is capable of accessing the at least one piece of pre-broadcast content at least a predefined period of time before the broadcast content is broadcast, and wherein the predefined period of time comprises the given time period.

6. A system according to claim 1, wherein the terminal is capable of storing at least one content usage statistic further comprising at least one statistic related to at least one of the terminal and the at least one piece of content accessed from the memory.

7. A system according to claim 1, wherein the terminal is capable of accessing at least one piece of content from a memory of a terminal in an offline manner.

8. A system according to claim 1, wherein the terminal is capable of being repeatedly triggered to obtain a location of the terminal and store at least one content usage statistic for at least one period of time, and wherein the terminal is further capable of sending the content usage log to the destination after each period of time.

9. A system according to claim 1, wherein the destination is capable of receiving the content usage log including the at least one content usage statistic such that a network entity is capable of sending, to the terminal, at least one piece of content based upon the at least one content usage statistic.

10. A system according to claim 1, wherein the terminal is capable of storing at least one content usage statistic further comprising at least one of a type of the at least one piece of content accessed from the memory, a time the at least one piece of content was accessed from memory, information regarding used connection types, and information regarding available connection types comprising at least one of a signal strength, capacity and utilization rate of the connection types.

11. A system for recording at least one content usage statistic comprising:
a terminal capable of accessing at least one piece of content from a memory, wherein the at least one piece of content comprises at least one piece of pre-broadcast content related to broadcast content, wherein the terminal is also capable of storing, into a content usage log, at least one content usage statistic relating to the terminal accessing the at least one piece of pre-broadcast content; and
a destination capable of receiving the content usage log including the at least one content usage statistic before the broadcast content is broadcast.

12. A system according to claim 11, wherein the terminal is capable of receiving at least one piece of content in accordance with a broadband data broadcast technique, and wherein the at least one piece of content comprises at least one piece of content for at least one channel comprising at least one of a television, radio and data channel.

13. A system according to claim 12, wherein the terminal is capable of sending the content usage log to the destination when a return channel between the terminal and the destination is at least one of available and established.

14. A system according to claim 11, wherein the terminal is capable of storing at least one content usage statistic further comprising at least one statistic related to at least one of the terminal and the at least one piece of content accessed from the memory.

15. A system according to claim 11, wherein the terminal is capable of accessing at least one piece of content from a memory of a terminal in an offline manner.

16. A system according to claim 11, wherein the terminal is capable of repeatedly accessing at least one piece of content and storing at least one content usage statistic for a period of time before the broadcast content is broadcast, and wherein the terminal is capable of sending the content usage log to the destination after the period of time and before the broadcast content is broadcast.

17. A system according to claim 11, wherein the at least one piece of pre-broadcast content comprises a set of at least one television program over a given time period for at least one television channel, wherein the terminal is capable of accessing the at least one piece of pre-broadcast content at least a predefined period of time before the broadcast content is broadcast, and wherein the predefined period of time comprises the given time period.

18. A system according to claim 11, wherein the destination is capable of receiving the content usage log including the at least one content usage statistic such that a network entity is capable of sending, to the terminal, at least one piece of content based upon the at least one content usage statistic.

19. A system according to claim 11, wherein the terminal is capable of storing at least one content usage statistic further comprising at least one of a type of the at least one piece of content accessed from the memory, a time the at least one piece of content was accessed from memory, information regarding used connection types, and information regarding available connection types comprising at least one of a signal strength, capacity and utilization rate of the connection types.

20. A terminal for recording at least one content usage statistic comprising:
a memory capable of receiving and storing at least one piece of content; and
a controller capable of accessing at least one piece of content from the memory, wherein the controller is capable of operating a client application, wherein the client application is capable of being triggered to obtain a location of the terminal by the controller accessing the at least one piece of content, and
wherein the memory is also capable of storing, into a content usage log, at least one content usage statistic relating to the controller accessing the at least one piece of content, wherein at least one content usage statistic comprises the location of the terminal.

21. A terminal according to claim 20, wherein the memory is capable of receiving at least one piece of content in accordance with a broadband data broadcast technique, and wherein the at least one piece of content comprises at least one piece of content for at least one channel comprising at least one of a television, radio and data channel.

22. A terminal according to claim 21, wherein the controller is capable of sending the content usage log to a destination when a return channel between the terminal and the destination is at least one of available and established.

23. A terminal according to claim 20, wherein the memory is capable of receiving and storing at least one piece of content comprising at least one piece of pre-broadcast content related to broadcast content, wherein the controller is capable of sending the content usage log to a destination before the broadcast content is broadcast.

24. A terminal according to claim 23, wherein the at least one piece of pre-broadcast content comprises a set of at least one television program over a given time period for at least one television channel, wherein the controller is capable of accessing the at least one piece of pre-broadcast content at least a predefined period of time before the broadcast content is broadcast, and wherein the predefined period of time comprises the given time period.

25. A terminal according to claim 20, wherein the memory is capable of storing at least one content usage statistic further comprising at least one statistic related to at least one of the terminal and the at least one piece of content accessed from the memory of the terminal.

26. A terminal according to claim 20, wherein the controller is capable of accessing at least one piece of content from a memory of a terminal in an offline manner.

27. A terminal according to claim 20, wherein the controller is capable of repeatedly accessing at least one piece of content, the client application is capable of repeatedly obtaining a location of the terminal, and the memory is capable of repeatedly storing at least one content usage statistic for at least one period of time, and wherein the controller is further capable of sending the content usage log to a destination after each period of time.

28. A terminal according to claim 20, wherein the memory is capable of storing at least one content usage statistic further comprising at least one of a type of the at least one piece of content accessed from the memory, a time the at least one piece of content was accessed from memory, information regarding used connection types, and information regarding available connection types comprising at least one of a signal strength, capacity and utilization rate of the connection types.

29. A terminal for recording at least one content usage statistic comprising:
a memory capable of receiving and storing at least one piece of content, wherein the at least one piece of content comprises at least one piece of pre-broadcast content related to broadcast content; and
a controller capable of accessing at least one piece of content from the memory,
wherein the memory is also capable of storing, into a content usage log, at least one content usage statistic relating to accessing the at least one piece of pre-broadcast content, and wherein the controller is capable of sending the content usage log to a destination before the broadcast content is broadcast.

30. A terminal according to claim 29, wherein the memory is capable of receiving at least one piece of content in accordance with a broadband data broadcast technique, and wherein the at least one piece of content comprises at least one piece of content for at least one channel comprising at least one of a television, radio and data channel.

31. A terminal according to claim 29, wherein the terminal is capable of sending the content usage log to the destination when a return channel between the terminal and the destination is at least one of available and established.

32. A terminal according to claim 29, wherein the memory is capable of storing at least one content usage statistic further comprising at least one statistic related to at least one of the terminal and the at least one piece of content accessed from the memory of the terminal.

33. A terminal according to claim 29, wherein the controller is capable of accessing at least one piece of content from a memory of a terminal in an offline manner.

34. A terminal according to claim 29, wherein the controller is capable of repeatedly accessing at least one piece of content and the memory is capable of repeatedly storing at least one content usage statistic for a period of time before the broadcast content is broadcast, and wherein the controller is capable of sending the content usage log to a destination after the period of time and before the broadcast content is broadcast.

35. A terminal according to claim 29, wherein the at least one piece of pre-broadcast content comprises a set of at least one television program over a given time period for at least one television channel, wherein the controller is capable of accessing the at least one piece of pre-broadcast content at least a predefined period of time before the broadcast content is broadcast, and wherein the predefined period of time comprises the given time period.

36. A terminal according to claim 29, wherein the memory is capable of storing at least one content usage statistic further comprising at least one of a type of the at least one piece of content accessed from the memory, a time the at least one piece of content was accessed from memory, information regarding used connection types, and information regarding available connection types comprising at least one of a signal strength, capacity and utilization rate of the connection types.

37. A method of recording at least one content usage statistic comprising:
accessing at least one piece of content from a memory of a terminal;
obtaining a location of the terminal, wherein accessing the at least one piece of content triggers obtaining the location of the terminal; and
storing at least one content usage statistic relating to accessing the at least one piece of content into a content usage log, wherein at least one content usage statistic comprises the location of the terminal.

38. A method according to claim 37 further comprising:
receiving at least one piece of content into the memory of the terminal in accordance with a broadband data broadcast technique, wherein the at least one piece of content comprises at least one piece of content for at least one channel comprising at least one of a television, radio and data channel.

39. A method according to claim 38 further comprising:
sending the content usage log to a destination when a return channel between the terminal and the destination is at least one of available and established.

40. A method according to claim 37 further comprising:
receiving at least one piece of content into the memory of the terminal, wherein the at least one piece of content comprises at least one piece of pre-broadcast content related to broadcast content;
sending the content usage log to a destination; and thereafter
broadcasting the broadcast content.

41. A method according to claim 40, wherein the at least one piece of pre-broadcast content comprises a set of at least one television program over a given time period for at least one television channel, wherein accessing at least one piece of content comprises accessing at least one piece of pre-broadcast content at least a predefined period of time before the broadcast content is broadcast, and wherein the predefined period of time comprises the given time period.

42. A method according to claim 37, wherein storing at least one content usage statistic comprises storing at least one content usage statistic further comprising at least one statistic related to at least one of the terminal and the at least one piece of content accessed from the memory of the terminal.

43. A method according to claim 37, wherein accessing at least one piece of content comprises accessing at least one piece of content from a memory of a terminal in an offline manner.

44. A method according to claim 37, wherein accessing at least one piece of content, obtaining a location of the terminal, and storing at least one content usage statistic comprise repeatedly accessing at least one piece of content, obtaining a location of the terminal, and storing at least one content usage statistic for at least one period of time, and wherein the method further comprises:
sending the content usage log to a destination after each period of time.

45. A method according to claim 37, wherein storing at least one content usage statistic comprises storing at least one content usage statistic further comprising at least one of a type of the at least one piece of content accessed from the memory, a time the at least one piece of content was accessed from memory, information regarding used connection types, and information regarding available connection types comprising at least one of a signal strength, capacity and utilization rate of the connection types.

46. A method of recording at least one content usage statistic comprising:
accessing at least one piece of content from a memory of a terminal, wherein the at least one piece of content comprises at least one piece of pre-broadcast content related to broadcast content;
storing at least one content usage statistic relating to accessing the at least one piece of pre-broadcast content into a content usage log;
sending the content usage log to a destination; and thereafter
broadcasting the broadcast content.

47. A method according to claim 46 further comprising:
receiving at least one piece of content into the memory of the terminal in accordance with a broadband data broadcast technique, wherein the at least one piece of content comprises at least one piece of pre-broadcast content for at least one channel comprising at least one of a television, radio and data channel.

48. A method according to claim 47, wherein sending the content usage log comprises sending the content usage log to a destination when a return channel between the terminal and the destination is at least one of available and established.

49. A method according to claim 46, wherein storing at least one content usage statistic comprises storing at least one content usage statistic further comprising at least one statistic related to at least one of the terminal and the at least one piece of content accessed from the memory of the terminal.

50. A method according to claim 46, wherein accessing at least one piece of content comprises accessing at least one piece of content from a memory of a terminal in an offline manner.

51. A method according to claim 46, wherein accessing at least one piece of content and storing at least one content usage statistic comprise repeatedly accessing at least one piece of content and storing at least one content usage statistic for a period of time before broadcasting the broadcast content, and wherein sending the content usage log comprises sending the content usage log to a destination after the period of time and before broadcasting the broadcast content.

52. A method according to claim 29, wherein the at least one piece of pre-broadcast content comprises a set of at least one television program over a given time period for at least one television channel, wherein accessing at least one piece of content comprises accessing the at least one piece of pre-broadcast content at least a predefined period of time before the broadcast content is broadcast, and wherein the predefined period of time comprises the given time period.

53. A method according to claim 29, wherein storing at least one content usage statistic comprises storing at least one content usage statistic further comprising at least one of a type of the at least one piece of content accessed from the memory, a time the at least one piece of content was accessed from memory, information regarding used connection types, and information regarding available connection types comprising at least one of a signal strength, capacity and utilization rate of the connection types.

54. A computer program product for recording at least one content usage statistic, the computer program product comprising a computer-readable storage medium having computer-readable program code portions stored therein, the computer-readable program code portions comprising:
a first executable portion for accessing at least one piece of content from a memory of a terminal;
a second executable portion for obtaining a location of the terminal, wherein the first executable portion accessing the at least one piece of content triggers the second executable portion to obtain the location of the terminal; and
a third executable portion for storing at least one content usage statistic relating to accessing the at least one piece of content into a content usage log, wherein at least one content usage statistic comprises the location of the terminal.

55. A computer program product according to claim 54 further comprising:
a fourth executable portion for receiving at least one piece of content into the memory of the terminal in accordance with a broadband data broadcast technique, wherein the at least one piece of content comprises at least one piece of content for at least one channel comprising at least one of a television, radio and data channel.

56. A computer program product according to claim 55 further comprising:
a fifth executable portion for sending the content usage log to a destination when a return channel between the terminal and the destination is at least one of available and established.

57. A computer program product according to claim 54 further comprising:
a fourth executable portion for receiving at least one piece of content into the memory of the terminal, wherein the at least one piece of content comprises at least one piece of pre-broadcast content related to broadcast content; and
a fifth executable portion for sending the content usage log to a destination before the broadcast content is broadcast.

58. A computer program product according to claim 57, wherein the at least one piece of pre-broadcast content comprises a set of at least one television program over a given time period for at least one television channel, wherein the first executable portion is adapted to access at least one piece of pre-broadcast content at least a predefined period of time before the broadcast content is broadcast, and wherein the predefined period of time comprises the given time period.

59. A computer program product according to claim 54, wherein the third executable portion is adapted to store at least one content usage statistic further comprising at least one statistic related to at least one of the terminal and the at least one piece of content accessed from the memory of the terminal.

60. A computer program product according to claim 54, wherein the first executable portion is adapted to access at least one piece of content from a memory of a terminal in an offline manner.

61. A computer program product according to claim 54, wherein the first executable portion is adapted to repeatedly access at least one piece of content, the second executable portion is adapted to repeatedly obtain a location of the terminal, and the third executable portion is adapted to repeatedly store at least one content usage for at least one period of time, and wherein the computer program product further comprises:
a fourth executable portion for sending the content usage log to a destination after each period of time.

62. A computer program product according to claim 54, wherein the third executable portion is adapted to store at least one content usage statistic further comprising at least one of a type of the at least one piece of content accessed from the memory, a time the at least one piece of content was accessed from memory, information regarding used connection types, and information regarding available connection types comprising at least one of a signal strength, capacity and utilization rate of the connection types.

63. A computer program product of recording at least one content usage statistic comprising:
a first executable portion for accessing at least one piece of content from a memory of a terminal, wherein the at least one piece of content comprises at least one piece of pre-broadcast content related to broadcast content;
a second executable portion for storing at least one content usage statistic relating to accessing the at least one piece of pre-broadcast content into a content usage log; and
a third executable portion for sending the content usage log to a destination before the broadcast content is broadcast.

64. A computer program product according to claim 63 further comprising:
a fourth executable portion for receiving at least one piece of content into the memory of the terminal in accordance with a broadband data broadcast technique, wherein the at least one piece of content comprises at least one piece of pre-broadcast content for at least one channel comprising at least one of a television, radio and data channel.

65. A computer program product according to claim 64, wherein the third executable portion is adapted to send the content usage log to a destination when a return channel between the terminal and the destination is at least one of available and established.

66. A computer program product according to claim 63, wherein the second executable portion is adapted to store at least one content usage statistic further comprising at least one statistic related to at least one of the terminal and the at least one piece of content accessed from the memory of the terminal.

67. A computer program product according to claim 63, wherein the first executable portion is adapted to access at least one piece of content from a memory of a terminal in an offline manner.

68. A computer program product according to claim 63, wherein the first executable portion is adapted to repeatedly access at least one piece of content and the second executable portion is adapted to storing at least one content usage statistic comprise repeatedly accessing at least one piece of content and storing at least one content usage statistic for a period of time before broadcasting the broadcast content, and wherein the third executable portion is adapted to send the content usage log to a destination after the period of time and before the broadcast content is broadcast.

69. A computer program product according to claim 63, wherein the at least one piece of pre-broadcast content comprises a set of at least one television program over a given time period for at least one television channel, wherein the first executable portion is adapted to access the at least one piece of pre-broadcast content at least a predefined period of time before the broadcast content is broadcast, and wherein the predefined period of time comprises the given time period.

70. A computer program product according to claim 63, wherein the second executable portion is adapted to store at least one content usage statistic further comprising at least one of a type of the at least one piece of content accessed from the memory, a time the at least one piece of content was accessed from memory, information regarding used connection types, and information regarding available connection types comprising at least one of a signal strength, capacity and utilization rate of the connection types.
